(19) United States
(12) Patent Application Publication
(10) Pub. No.: US 2017/0344956 A1
(43) Pub. Date: Nov. 30, 2017

(54) USER CALENDAR CONTROL FOR WEB PAGE

(71) Applicant: Microsoft Technology Licensing, LLC, Redmond, WA (US)

(72) Inventors: Jason Morris Yore, Seattle, WA (US); Shane Wyatt Zamora, Bellevue, WA (US); Akshatha Kommalapati, Kirkland, WA (US); Song Zou, Bellevue, WA (US); Christopher Doan, Seattle, WA (US)

(21) Appl. No.: 15/167,732

(22) Filed: May 27, 2016

(51) Int. Cl. G06Q 10/10; G06F 3/0484; G06F 3/0481; G06F 17/24; H04L 29/08; G06F 17/30

(52) U.S. Cl. CPC G06Q 10/1095; H04L 67/10; H04L 67/02; G06F 17/3089; G06F 3/0481; G06F 17/24; G06F 3/0484; G06F 17/30864

(57) ABSTRACT

A calendar control that shows user calendar data in the context of a website. When a computing system accesses a web page from a website, there is a reference to a calendar control associated with that web page. The computing system (e.g., perhaps a browser) uses the reference to the calendar control to access the calendar control. The calendar control is then executed which causes calendar data for the user that navigated to the web site to be gathered from an external data source. Accordingly, the calendar control is shown in conjunction with the web page, but includes user calendar data that the website does not necessarily have direct access to. The calendar control may also have an interface that allows the user and/or the website to edit the user's calendar information.

### BACKGROUND

Computers and networks have ushered in what has been called the “information age”. There is a massive quantity of data available that can assist users in managing their life. When it comes to managing life (or any sequence of events), an important type of data is referred to herein as calendar data. Calendar data includes, for instance, any data that is associated with a particular time (such as appointments, reminders, log entries, pictures, videos, and so forth) that have a date or dates associated with it. Often, calendar data also includes an associated time.

Electronic calendars provide a user interface that allows a user to navigate through various month views, week views, day views, and so forth, in order to find some types of calendar data within the scope of the navigation. For instance, a user might navigate to a particular day to find all appointments for that date, or navigate to a particular week to find all appointments for that week. The various calendar views also often visually distinguish free time from busy time. Electronic calendars thus provide a valuable tool for users to manage their time—an often scarce resource.

There exist some electronic calendars that aggregate calendar information from multiple other electronic calendars. Websites also often have calendars that allow data to be populated therein by the website owner. For instance, an airline reservation website might provide a calendar control to allow a user to select a date range for travel. As another example, a user might navigate to a doctor's website and select a date and time for an appointment.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to the use of a calendar control that shows user calendar data in the context of a website. When a computing system accesses a web page from a website, there is a reference to a calendar control associated with that web page. The computing system (e.g., perhaps a browser) uses the reference to the calendar control to access the calendar control. The calendar control is then executed which causes calendar data for the user that navigated to the web site to be gathered from an external data source.

For instance, the calendar control may access the calendar data of that user using an interface that is not provided by the website. As an example, the calendar data may be provided by a calendar service offered in a cloud computing environment and/or from the computing system itself, and/or from some other source. The calendar control has an associated visualization that is displayed within the web page at the computing system. Accordingly, the calendar control is shown in conjunction with the web page, but includes user calendar data that the website does not necessarily have direct access to. The calendar control may also have an interface that allows the user and/or the website to edit the user's calendar information.

Thus, the principles described herein provide a combination of 1) providing of the visualization of the calendar control within the web page, and 2) populating of the visualization with user's calendar information. This combination offers a highly integrated experience for the user. For instance, a user might navigate to an airlines website, and when at the reservation web page, may be able to see the user's personal calendar information. Thus, for instance, the user might avoid making a flight reservation when travelling would cause the user to miss a key appointment or event. Thus the principles described herein provide a key tool that allows the user to manage his or her time, even in the context of working with a website that might itself beforehand have no concept about the user's calendar. Furthermore, the providing of the interface that allows the calendar information to be edited allows new calendar information to be added on the spot, by interfacing with the calendar control within the website.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing system in which the principles described herein may be employed;

FIG. 2 illustrates an example environment in which the principles describe herein may operate in which a data structure (e.g., a web page) having a calendar control embedded therein that retrieves user calendar data from an external calendar source;

FIG. 3 illustrates a flowchart of a method for operating a computing system to display user calendar information in the context of a web page in accordance with the principles described herein;

FIG. 4 illustrates a flowchart of a method for operating the calendar control in accordance with the principles described herein;

FIG. 5 illustrates an example calendar control that represents an example of the calendar control of FIG. 2;

FIG. 6 illustrates an example visualization of a calendar control, which is an example of a visualization of the calendar control of FIG. 2 and the calendar control of FIG. 5;

FIG. 7 illustrates an architecture of an external calendar data source that is an example of the external calendar data source of FIG. 2;

FIG. 8 illustrates a time user interface that represents an example of the time user interface of FIG. 7, and which includes a time-associated data portion that is populated to time-associated data related to the focal date of the time user interface; and

FIG. 9 illustrates a visualization of a calendar control that has been altered due to the user selecting a different focal date, causing a change in the calendar data shown in a portion of the calendar control.

### DETAILED DESCRIPTION

At least some embodiments described herein relate to the use of a calendar control that shows user calendar data in the context of a website. When a computing system accesses a web page from a website, there is a reference to a calendar control associated with that web page. The computing system (e.g., perhaps a browser) uses the reference to the calendar control to access the calendar control. The calendar control is then executed which causes calendar data for the user that navigated to the web site to be gathered from an external data source.

For instance, the calendar control may access the calendar data of that user using an interface that is not provided by the website. As an example, the calendar data may be provided by a calendar service offered in a cloud computing environment and/or from the computing system itself, and/or from some other source. The calendar control has an associated visualization that is displayed within the web page at the computing system. Accordingly, the calendar control is shown in conjunction with the web page, but includes user calendar data that the website does not necessarily have direct access to. The calendar control may also have an interface that allows the user and/or the website to edit the user's calendar information.

Thus, the principles described herein provide a combination of 1) providing of the visualization of the calendar control within the web page, and 2) populating of the visualization with user's calendar information. This combination offers a highly integrated experience for the user. For instance, a user might navigate to an airlines website, and when at the reservation web page, may be able to see the user's personal calendar information. Thus, for instance, the user might avoid making a flight reservation when travelling would cause the user to miss a key appointment or event. Thus the principles described herein provide a key tool that allows the user to manage his or her time, even in the context of working with a website that might itself beforehand have no concept about the user's calendar. Furthermore, the providing of the interface that allows the calendar information to be edited allows new calendar information to be added on the spot, by interfacing with the calendar control within the website.

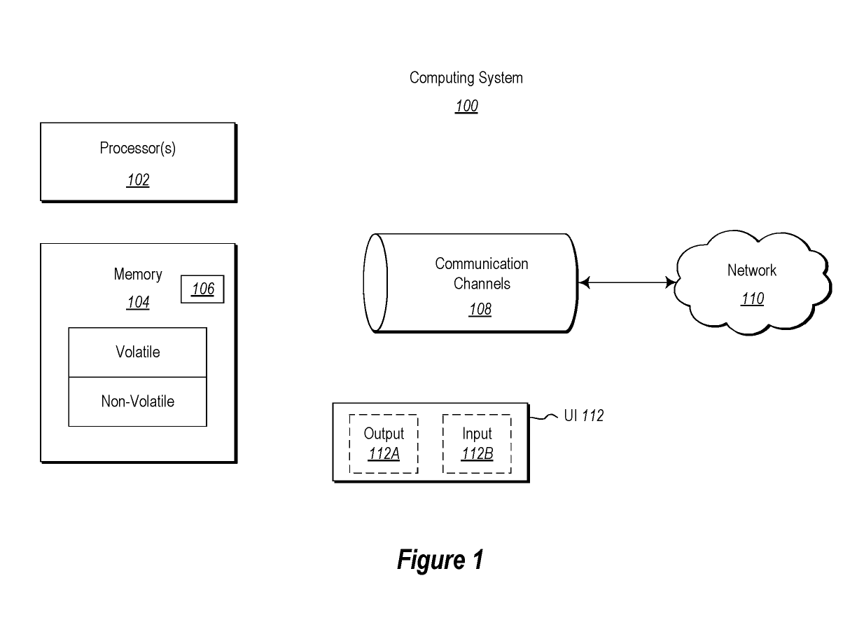

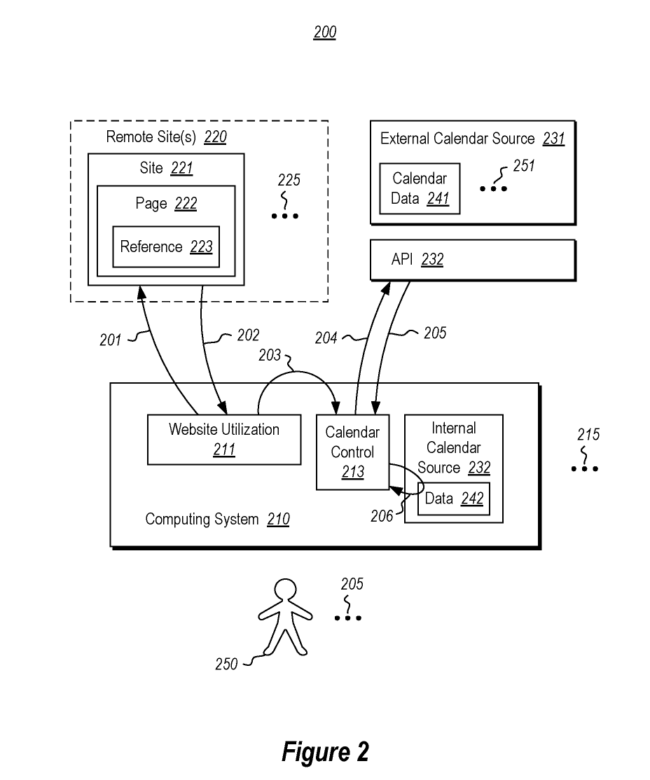

Some introductory discussion of a computing system will be described with respect to FIG. 1. Then, the operation of the calendar control to expose the user's calendar data within the context of a website will be described with respect to FIGS. 2 through 9.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “virtual machine”, “control” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms, virtual reality elements, and so forth. Examples of input mechanisms 112B might include, for instance, microphones, touchscreens, holograms, cameras, keyboards, mouse of other pointer input, sensors of any type, virtual reality elements, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

FIG. 2 illustrates an environment 200 in which the principles described herein may operate. The environment 200 includes a computing system 210 that has an associated user 201. The computing system 210 may be structured as described above for the computing system 100 of FIG. 1. The computing system 210 may have associated therewith a website utilization component 211, which is able to navigate to sites (e.g., websites) and retrieve and interpret data structures (e.g., web pages) provided by those sites. For instance, the user 201 might be using the computing system 210 to browse the web.

The environment 200 also includes one or more remote sites 220. As an example, the one or more remote sites 220 may include a site 221, and potentially other sites as represented by the ellipses 225. The one or more remote sites 220 may, for instance, include one or more remote servers that may be navigated to using, for instance, the Internet. The site 221 is illustrated as providing a data structure 222 which has therein a reference 223 to a calendar control.

In the example that is described hereinafter, the web utilization component 211 is a web browser, the sites 220 are websites, and the downloaded data structure 222 is a web page. Accordingly, the web utilization component 211, the site 221, and the downloaded data structure 222 may also be referred to hereinafter as a browser 211, a website 221, and a web page 222, respectively. However, the principles described herein are not limited to this particular example.

The environment 200 also includes an external calendar data source 231 that has user calendar data 241 associated with the user 201 as well as potential other user calendar data (represented by ellipses 251) associated with other users (represented by ellipses 205) that are using yet other computing systems (represented by ellipses 215). As an example, the external calendar data source 231 could be a service offered in a cloud computing environment. In that case, the external calendar source 231 may have user calendar data for thousands, millions, or even perhaps billions of users.

The environment 200 also potentially includes an internal calendar data source 232 that is internal to the computing system 210, and that also includes user calendar data 242 for potentially multiple users including the user 201. The user calendar data 242 might include, for instance, cached calendar information previously gathered from the external calendar source 231 and/or calendar information provided by one or more applications that are running or that previously ran on the computing system. Furthermore, when the term “web page” or “page” is used hereinafter in this description, it will thus be understood that the downloaded data structure 222 is also being referenced more broadly. Furthermore, when the term “website” is used hereinafter, it will be understood that the site 221 is being referenced more broadly.

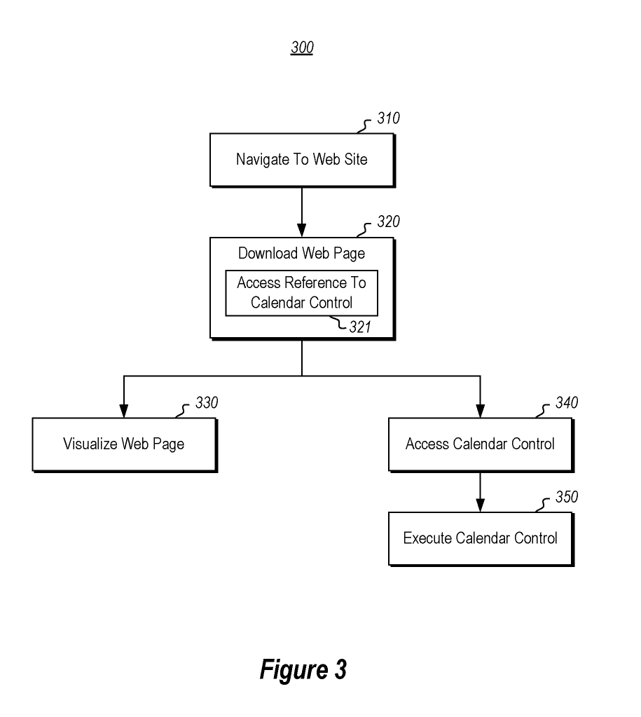

FIG. 3 illustrates a flowchart of a method 300 for operating a computing system to display user calendar information in the context of a web page in accordance with the principles described herein. For instance, the method 300 may be performed by the computing system 210 of FIG. 2. The computing system navigates (act 310) to a remote website. For instance, in FIG. 3, the site utilization component 211 navigates (as represented by arrow 201) to the website 221. As a result, a web page is downloaded to the computing system (act 320). For instance, in FIG. 2, the browser 211 receives the web page 222 (as represented by arrow 202).

Unlike a conventional web page, the web page 222 includes a reference 223 to a calendar control that allows a visualization of the calendar control to be rendered in the context of the web page whilst being automatically populated by the user's calendar data. Accordingly, the act of downloading the web page (act 320) includes an act of accessing a reference to a calendar control (act 321).

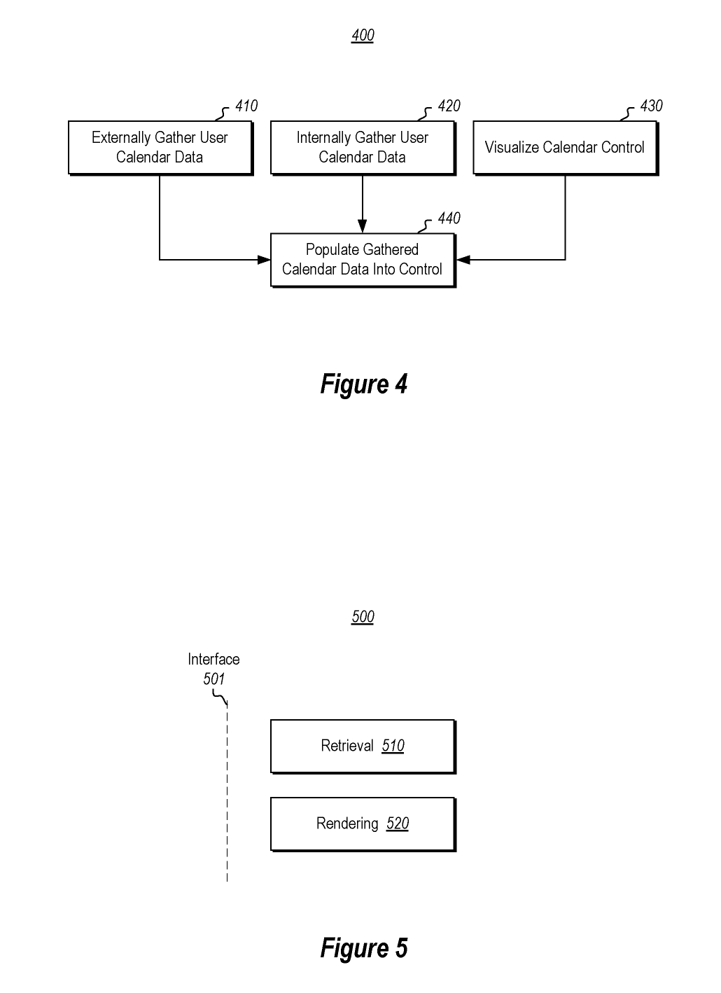

The downloaded web page is then visualized (act 330) by the browser. For instance, in FIG. 2, the browser 211 renders the web page 222 on a display of the computing system 210. Furthermore, the reference to the calendar control is used by the computing system to access the calendar control (act 340). This accessing of the calendar control may be performed at, or prior to rendering the web page. The accessing is represented in FIG. 2 by arrow 203, and the accessed calendar control is represented by the calendar control 213. Although not shown in FIG. 2, the calendar control may be accessed from an interface that is not provided by the website 221. The computing system then executes the calendar control (act 350). The execution of the calendar control triggers operation of the calendar control, which may operate according to the method 400 described with respect to FIG. 4. Possibly, all or a portion of the method 400 may be performed at or before the time that the downloaded web page is visualized (act 330).

FIG. 4 illustrates a flowchart of a method 400 for operating the calendar control. The calendar control gathers calendar data for the user of the computing system from an external data source (act 410). For instance, in FIG. 2, as represented by arrow 204, the calendar control 213 interfaces with an interface 232 provided by the external calendar data source in order to retrieve (as represented by arrow 205) all or some of the calendar data 241 associated with the user 201. The API 232 is not provided by the website 221 that provided the web page 222 that has the reference 223 to the calendar control, but is instead external to that website 221. As an example, the API 232 might be a cloud service API.

Alternatively, or in addition, the calendar control gathers calendar data for the user of the computing system from the computing system itself (act 420). This gathering is represented in FIG. 2 by arrow 206. The gathered calendar information from the computing system might be, for instance, cached calendar information previously gathered from the external calendar data source 231. Alternatively, or in addition, this gathering (represented by arrow 206) may be of calendar data provided by one or more applications that are running or that previously ran on the computing system 210.

A visualization of the calendar control is also rendered (act 430). This rendering may be performed at the time the web page itself is rendered (or perhaps sometime thereafter). However, to reduce latency and the appearance of latency, perhaps a default version of the calendar control (unpopulated with user calendar data) is rendered with the web page. The gathered calendar data is then populated into the visualization of the calendar control (act 440).

The acts 410, 420 and 430 are illustrated in parallel to emphasize that there is no temporal ordering required with respect to the acts. However, in order to reduce latency, and the appearance thereof, it may be that an unpopulated version of the calendar control is immediately rendered. Thereafter, whenever calendar data is gathered from whatever source, that calendar data may be immediately populated into the calendar control, to further reduce latency, or the appearance of latency, associated with rendering the calendar control.

As an example, suppose that the local gathering of user calendar data (presented by arrow 206) occurs much faster than the external gathering of user calendar data (represented by arrows 204 and 205). In this case, the locally gathered user calendar data may first be populated into the visualization of the calendar control, followed shortly thereafter by the externally gathered user calendar data being populated into the visualization of the calendar control. Thus, the principles described herein allow for reduced latency associated with rendering user calendar data without the visualization of a calendar control that is visualized in the context of a web page.

FIG. 5 illustrates an example calendar control 500 that represents an example of the calendar control 213 of FIG. 2. The calendar control 500 includes a retrieval component 510 and a rendering component 520. For instance, the retrieval component 510 may retrieve the user calendar data (as represented by acts 410 and 420 of FIG. 4 and arrows 204 through 206 of FIG. 2). On the other hand, the rendering component 520 may cause the visualization of the calendar control and the retrieved data to be rendered (as represented by acts 430 and 440 of FIG. 4).

The calendar control 500 further provides an interface 501 for allowing calendar information for the user to be edited. For instance, the calendar control might provide a visualization on the user interface that allows the user of the computing system to interact with the calendar control (via the interface 501) to edit the calendar information for the user. Furthermore, a website might also be permitted to edit the calendar information for the user (e.g., via the interface 501).

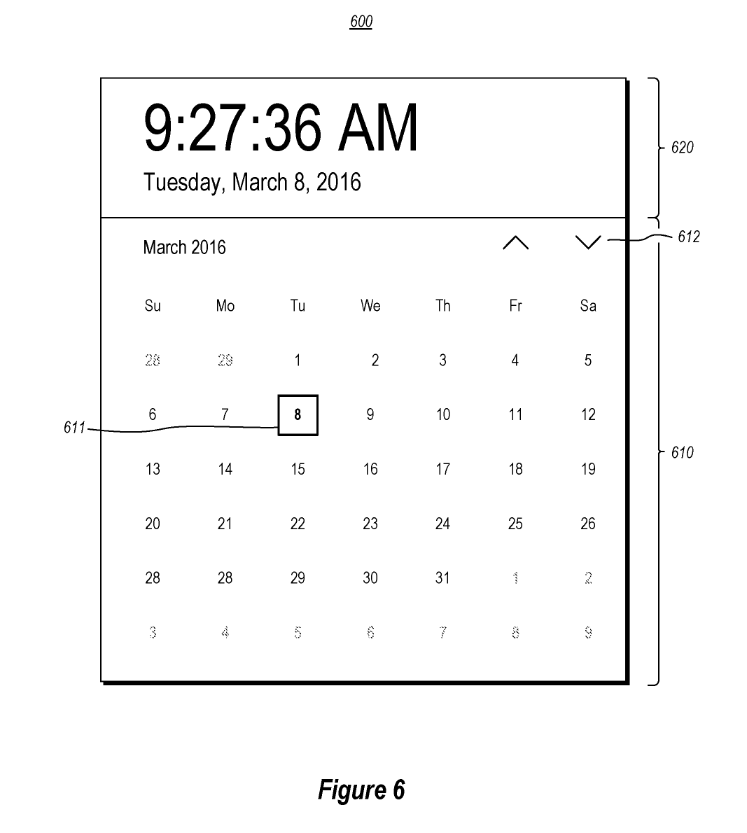

FIG. 6 illustrates an example visualization of a calendar control 600, which is an example of a visualization of the calendar control 213 of FIG. 2 and the calendar control 500 of FIG. 5. The calendar control 600 shows a month view 610 with the current date 611 highlighted; and a current time view 620 that shows the time to the second. There are also navigation controls 612 that allow the user to navigate to a different month of the same year, or other months of other years.

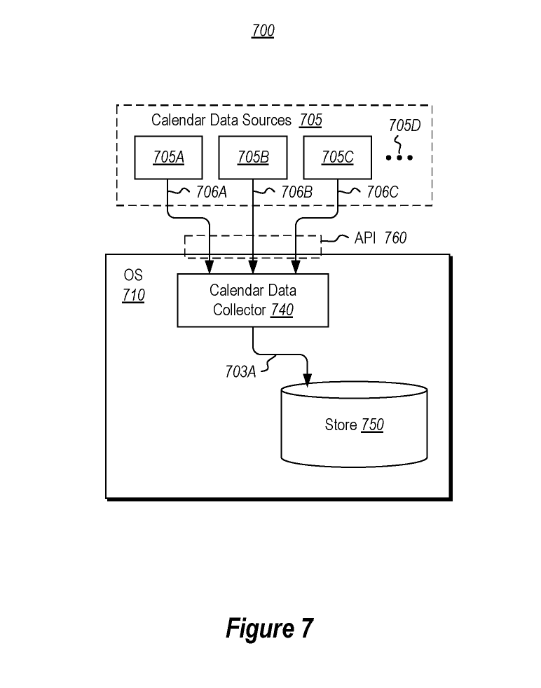

FIG. 7 illustrates an architecture of an external calendar data source 700 that is an example of the external calendar data source 231 of FIG. 2. The external calendar data source 700 includes a computing system 710 that may be structured as described above for the computing system 100 of FIG. 1. The computing system 710 interacts with various time-associated data sources 705, and includes various additional components that collaborate with calendar control. In particular, the calendar control may be populated with calendar data coming from external from the computing system 710 itself (e.g., from computing system 210 of FIG. 2, from another cloud service, or elsewhere). Furthermore, the calendar control may be populated with presentation instructions for how the calendar control should present the calendar data. When populating the visualization of the calendar control, the calendar control may take such presentation instructions into consideration. Thus, the website author may instruct that the calendar control be presented in a manner that is consistent with the appearance of the website.

The computing system 710 includes a time associated data collector module 740 that collects calendar data (and corresponding presentation instruction) from at least one calendar data source 705 outside of the operating system. For instance, the computing system 710 may provide an API 760 for interfacing with the calendar data collector 740 to provide such calendar data and corresponding presentation instruction. In FIG. 7, there are three calendar data sources 705A through 705C illustrated. However, the ellipses 705D represent that the collector module 740 may collect calendar data from any number of sources from as few as one, and with no upper limit contemplated.

The calendar sources 705 may be any source of calendar data including, for instance, an application run by the computing system 210, the computing system 710, another service, or the like. For instance, a calendar application, a task reminder application, a log application, a diary application, and so forth, are prime sources of calendar data. The calendar data sources 705 may include one or more programs that are local to the computing system 710, and or one or more programs that are remote from the computing system 710. Accordingly, there is no limit to the types of calendar data sources included within the calendar data sources 705. They may be local to, and/or remote from, the computing system 700 and may perform any function.

The collection operation (of both time-associated data and corresponding presentation instructions) is represented by arrows 706A through 706C from each of the calendar data sources 705A through 705C. In one embodiment, as the calendar data is collected, the collected time associated data and presentation instructions may then be placed into an external calendar store 750. The store 750 may be any device and/or system capable of storing data such as, for instance, a file, a database, or the like. The arrow 703A represents the collected calendar data being placed into the calendar data store 750.

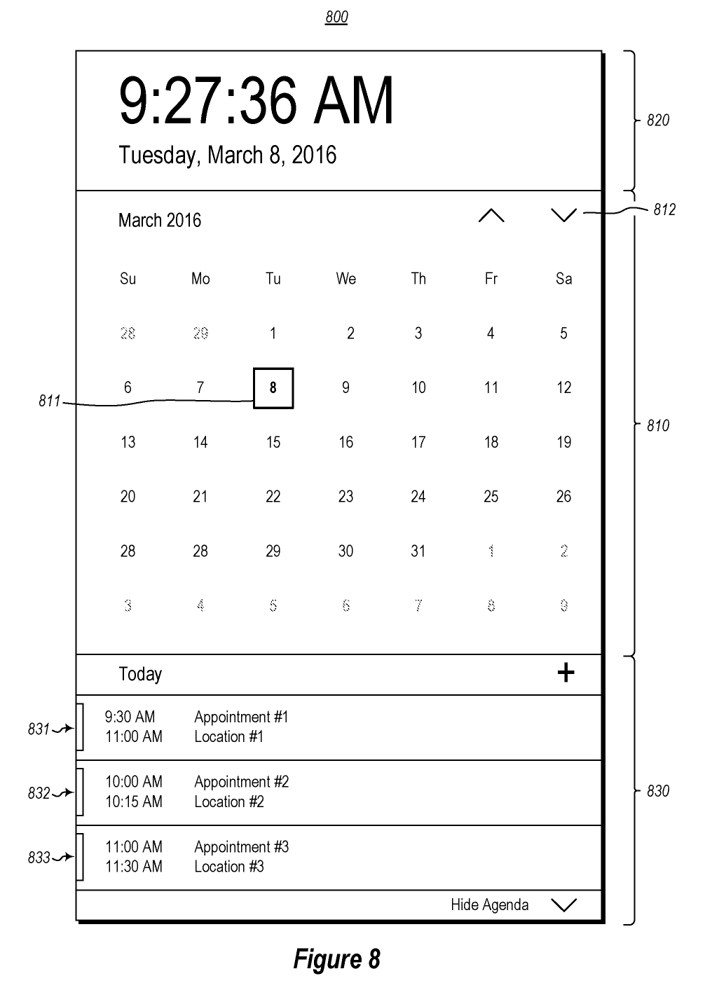

FIG. 8 illustrates a time user interface 800 that represents an example of the visualization of the calendar control. The time user interface 800 includes a month view 810 that visually emphasizes the focal date 811. For instance, as a default, when triggered the time user interface 800 may have a focal date of today. The time user interface also has a current time view 820 that shows the time to the second. There are also navigation controls 812 that allow the user to navigate to a different month of the same year, or other months of other years. The user is able to change the focal date, and corresponding calendar data related the changed focal date is populated within the time user interface. As an example, there may be a special calendar data portion of the time user interface that shows the populated time-associated data. This is the case with FIG. 8, which shows that the time user interface 800 includes a calendar data portion 830 that include calendar data 831, 832 and 833. In the state of FIG. 8, the focal date is the current date (which for purposes of this example is Mar. 8, 2016).

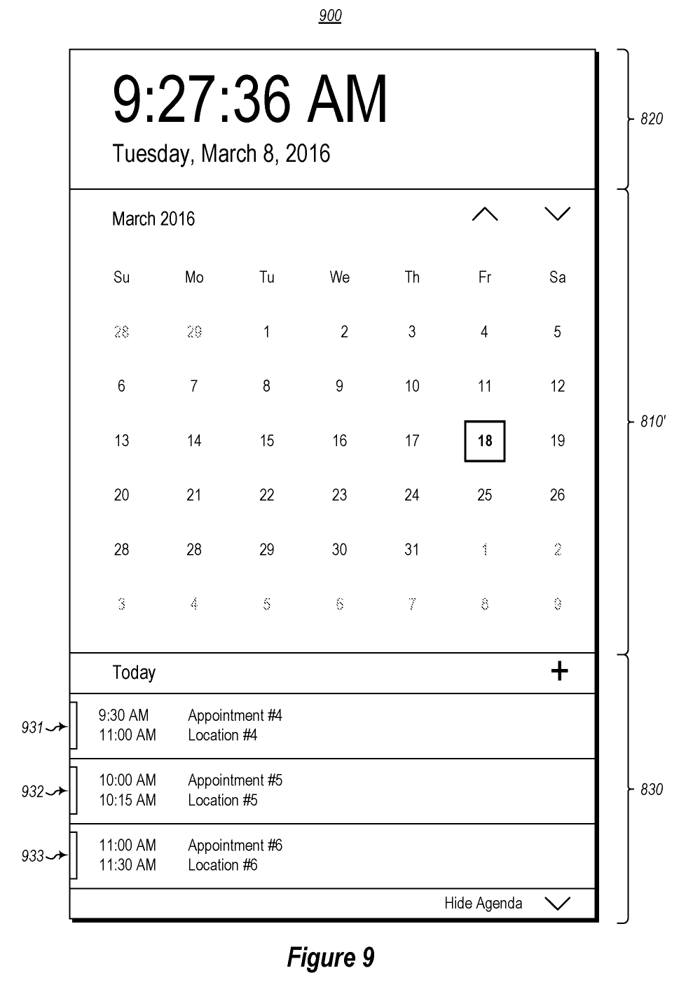

By changing the focal date, the calendar data changes also. For instance, FIG. 9 illustrates a visualization of a calendar control that has been altered due to the user selecting Mar. 18, 2016, causing portion 810 with Mar. 8, 2016 highlighted in FIG. 8 to change to portion 810′ with Mar. 18, 2016 highlighted in FIG. 9. In one embodiment, the current time view 820 stays the same so that the user still has a view on the current time. However, the content of portion 830 of FIG. 8 has been altered to result in portion 830′ of FIG. 9. Now, different calendar appointments are shown for Mar. 18, 2016. This includes appointment #4 (at location #4) shown as entry 931, appointment #5 (at location #5) shown as entry 932, and appointment #6 (at location #6) shown as entry 933.

Accordingly, the principles described here allow the user to be provided with their own calendar information within a calendar control that is within a website that the user navigated to. The present invention may be embodied in other forms, without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system comprising an operating system that comprises:
one or more processors;
one or more computer-readable media having thereon computer-executable instructions that are structured such that, when executed by the one or more processors, cause the computing system to perform the following in response to accessing a reference to a calendar control associated with a web page from a website:
an act of using the reference to the calendar control to access the calendar control, the calendar control being structure such that, when executed by the one or more processors, the calendar control gathers calendar data for a user of the computing system from an external calendar source and causes a visualization of the calendar control to be displayed within the web page with the gathered calendar data; and
an act of executing the calendar control causing the calendar data to be gathered from the external data source, and causing the web page to be displayed containing the visualization of the calendar control with the visualization of the gathered calendar data.

2. The computing system in accordance with claim 1, the calendar control further providing an interface for allowing calendar information for the user to be edited.

3. The computing system in accordance with claim 2, the visualization of the user interface also allows the user of the computing system to interact with the calendar control to edit the calendar information for the user.

4. The computing system in accordance with claim 2, the calendar control further allowing the website to edit the calendar information for the user.

5. The computing system in accordance with claim 2, the calendar control further allowing the website to edit the calendar information for the user using the interface provided by the calendar control.

6. The computing system in accordance with claim 1, the calendar control gathering calendar data for a user of the computing system from an external calendar source using an interface that is not provided by the website.

7. The computing system in accordance with claim 1, the external calendar source comprising a calendar service offered in a cloud computing environment.

8. The computing system in accordance with claim 1, the external calendar source gathering calendar information for the user from a plurality of sources.

9. The computing system in accordance with claim 1, the calendar control further configured to gather calendar information from the computing system.

10. The computing system in accordance with claim 9, the gathered calendar information from the computing system comprising cached calendar information previously gathered from the external calendar source.

11. The computing system in accordance with claim 9, the gathered calendar information from the computing system comprising calendar information provided by one or more applications that are running or that previously ran on the computing system.

13. A computing system comprising an operating system that comprises:
one or more processors;
one or more computer-readable media having thereon computer-executable instructions that are structured such that, when executed by the one or more processors, cause the computing system to execute and/or instantiate a calendar control, the calendar control being structured to perform a method when executed by the one or more processors, the method comprising:
an act of gathering calendar data for a user of the computing system from an external calendar source; and
causing a visualization of the calendar control to be displayed within a web page with the gathered calendar data; and
an act of populating the visualization of the calendar control within the visualization of the gathered calendar data.

14. The computing system in accordance with claim 13, the method further comprising:
an act of providing an interface for allowing calendar information for the user to be edited.

15. The computing system in accordance with claim 14, the visualization of the user interface allowing the user of the computing system to interact with the calendar control to edit the calendar information for the user.

16. The computing system in accordance with claim 14, the interface allowing the website that hosts the web page to edit the calendar information for the user.

17. The computing system in accordance with claim 13, the calendar control gathering calendar data for a user of the computing system from an external calendar source using an interface that is not provided by the website.

18. The computing system in accordance with claim 13, the external calendar source comprising a calendar service offered in a cloud computing environment.

19. The computing system in accordance with claim 13, the calendar control further configured to gather calendar information from the computing system.

20. A computer-implemented method for presenting calendar information for a user in the context of a web page, the method comprising:
an act of gathering calendar data for a user of the computing system from an external calendar source;
an act of causing a visualization of the calendar control to be displayed within a web page with the gathered calendar data; and
an act of populating the visualization of the calendar control within the visualization of the gathered calendar data.
